(19) United States
(12) Patent Application Publication
(10) Pub. No.: US 2018/0365350 A1
(43) Pub. Date: Dec. 20, 2018

(54) GENERATING CIRCUITS

(71) Applicant: Robert Anue, Los Gatos, CA (US)

(72) Inventor: Robert Anue, Los Gatos, CA (US)

(21) Appl. No.: 16/001,122

(22) Filed: Jun. 6, 2018

Related U.S. Application Data
(60) Provisional application No. 62/519,743, filed on Jun. 14, 2017.

(51) Int. Cl. G06F 17/50; G06N 99/00

(52) U.S. Cl. CPC G06F 17/505; G06F 2217/86; G06N 99/005

(57) ABSTRACT

Implementations generally relate to generating circuits. In one implementation, a method includes generating accumulated statistics, where the generating of the accumulated statistics is repeated based on one or more generation criteria. In some implementations, the generating of the accumulated statistics includes generating one or more changed versions of a current circuit, where the current circuit includes logic cells that perform Boolean operations, generating statistics associated with performance of the one or more changed versions based on the application of a training set to each changed version, and adding the generated statistics associated with each changed version to the accumulated statistics. The method further includes selecting a changed version from the one or more changed versions based on the accumulated statistics, updating the current circuit based on the selected changed version, and repeating the method multiple times based on the accumulated statistics.

### BACKGROUND

The field of machine learning may be described as a subfield of computer science that gives computers the ability to learn without being explicitly programmed. Machine learning typically involves generating computer code from a specification that includes a set of examples that define a desired computational task that the code executes.

### SUMMARY

Implementations generally relate to generating circuits. In one implementation, a method includes generating accumulated statistics, where the generating of the accumulated statistics is repeated based on one or more generation criteria. In some implementations, the generating of the accumulated statistics includes: generating one or more changed versions of a current circuit where the current circuit includes logic cells that perform Boolean operations, generating statistics associated with performance of the one or more changed versions based on the application of a training set to each changed version, and adding the generated statistics associated with each changed version to the accumulated statistics. The method further includes selecting a changed version from the one or more changed versions based on the accumulated statistics, updating the current circuit based on the selected changed version, and repeating the method multiple times based on the accumulated statistics.

Other aspects and advantages of the described implementations will become apparent from the following detailed description, taken in conjunction with the accompanying drawings, illustrating by way of example the principles of the described implementations.

### BRIEF DESCRIPTION OF THE DRAWINGS

FIG. 1 illustrates a block diagram of major software components, according to some implementations.

FIG. 2 illustrates an example high-level flow diagram for generating a circuit, according to some implementations.

FIG. 3 illustrates high-level flow diagram for generating accumulated statistics, according to some implementations.

FIG. 4 illustrates a block diagram of an example of the current circuit, according to some implementations.

FIG. 5 illustrates a block diagram of an example of a changed circuit according to some implementations.

FIG. 6 illustrates a block diagram for one particular type of logic cell, according to some implementations.

FIG. 7 illustrates a block diagram for an example logic cell with a more complex Boolean operation, according to some implementations.

FIG. 8 illustrates a block diagram for an example Boolean logic cell that generates its outputs based on a truth table, according to some implementations.

FIG. 9 illustrates a block diagram of an example computing system, which may be used for some implementations described herein.

### DETAILED DESCRIPTION

Implementations generally relate to generating circuits. A system generates networks of simple computing elements that perform a desired computing task that is specified by a training set. Unlike the conventional methods for creating artificial neural networks (ANNs), implementations described herein generate a network including logic cells that perform Boolean logic operations, which are more efficient than the logic cells used in ANNs.

Implementations enable the automated generation of circuits to perform a desired computing task that is described by a collection of examples in a training set. In some implementations, the system generates a circuit that includes simple computing elements called logic cells, which calculate their outputs by means of Boolean logic operations. In various implementations, a system may use hardware, software, or a combination thereof to generate circuits. Various implementations described herein may be applied to various technologies such as handwriting recognition, speech recognition, self-driving cars, and even, as described below, the automatic generation of circuits.

In an example implementation, the system may generate a circuit for categorization. In this example implementation, the system may generate a circuit to perform the categorization of handwritten digits “0” through “9” by performing handwriting recognition. The training set for such categorization may contain examples including an image of a digit along with the category to which it belongs (e.g., an image of a handwritten number “7” with the category “7”). In an example implementation, the system may generate a circuit with an output that asserts the Boolean value “True” when the circuit infers that the image applied to the inputs of the circuit belongs to category “7”.

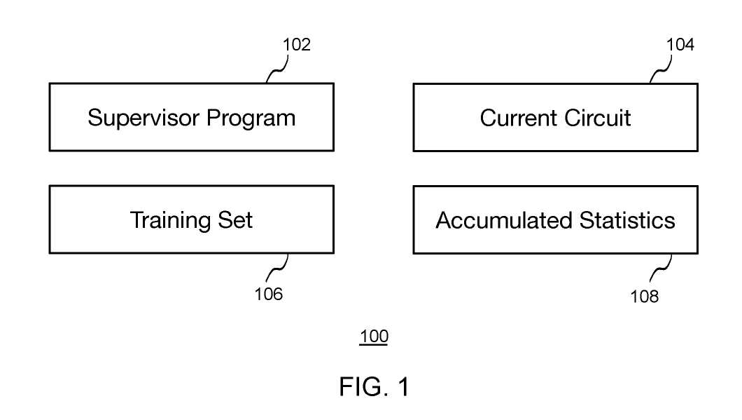

FIG. 1 illustrates a block diagram of major software components 100, according to some implementations. As shown, the major software components include a supervisor program 102, a current circuit 104, a training set 106, and accumulated statistics 108. In various implementations, the supervisor program 102 is the process that performs implementations described herein. A current circuit 104 is the current state of the circuit, which is being generated by implementations described in more detail herein. A training set 106 is the collection of example vectors that describe the desired computing task that the current circuit is generated to perform. The accumulated statistics 108 are the information that the supervisor program generates as it performs the implementations described herein.

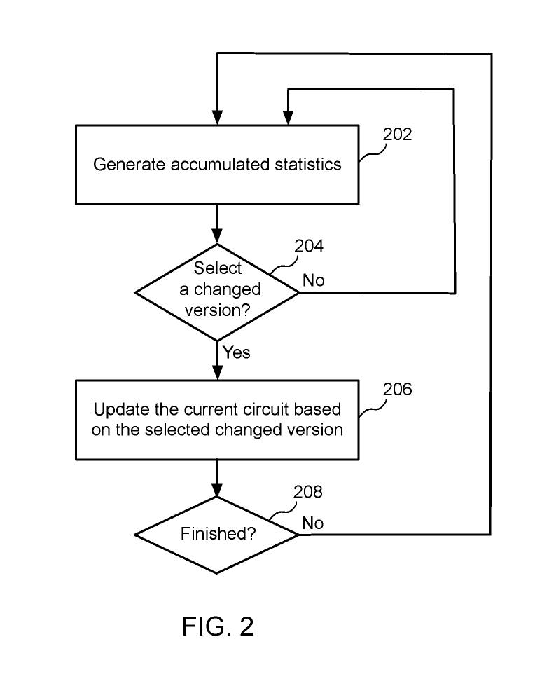

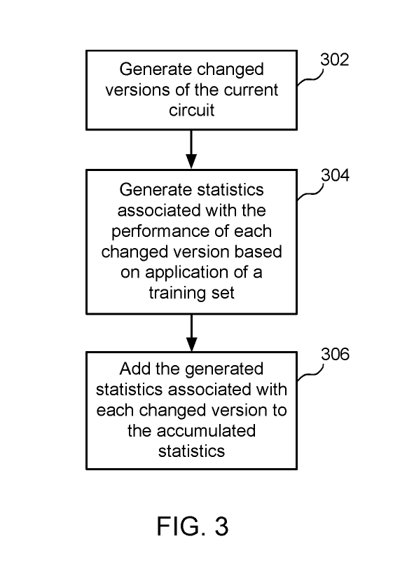

FIG. 2 illustrates an example high-level flow diagram for generating a circuit, according to some implementations. Referring to FIGS. 1 and 2, a method is initiated at block 202, where the system 100 generates accumulated statistics 108. In some implementations, the generating of the accumulated statistics 108 involves generating and measuring the results of a number of different possible changed versions of the current circuit. As described in more detail herein, generating the accumulated statistics 108 is repeated based on one or more generation criteria. FIG. 3 illustrates an example process of generating accumulated statistics in greater detail.

At block 204, the system 100 decides whether to select a changed version of a current circuit from one or more changed versions based on the accumulated statistics. In various implementations, a task of block 204 is to select a changed version that is “better” than the current circuit. In various implementations, the term “better” indicates that the changed circuit is an improvement over the current circuit. For example, a “better” version may produce fewer errors than the current circuit. By constantly selecting the “better” version each time through the loop created by block 208, the current circuit undergoes a process of incremental improvement. In various implementations, the accumulated statistics are the means for measuring the “better” version. Example measures for selecting the “better” version are described in more detail herein.

Some measures used to determine “better” versions of a network may include counting and reducing categorization errors. Categorization errors may be divided into two types. A first type of categorization error is a false positive. A false positive occurs when an example not belonging to a category is wrongly inferred to belong to it. In the example application, this will occur when the output for category “7” generates a True value when an image of category “1” is applied to the circuit. The second type of categorization error is a false negative. A false negative occurs when an example belonging to a category is inferred to not belong it. In the example application, a false negative would occur when the output for category “7” is false when the image of a “7” is applied to the inputs of the circuit. As such, when a circuit is generated to perform a categorization and the measure for the “better” version reduces an error rate, the accumulated statistics will contain a measure of the error rate. In some implementations, the error rate of an output is calculated from stored counts of the false positive inferences in a training set, and stored counts of the false negative inferences in a training set. These counts, along with the count of the total number of examples in the training set, define the true positive and true negative inferences. In various implementations, the generating of the statistics may include counting false positive inferences, and counting false negative inferences.

In some implementations, a measure for the “better” version may be a measurement of a reduction of the cost to create a circuit. In some implementations, the accumulated statistics 108 store numeric measures of the cost of the changed version. Numeric measures of the cost of a circuit may include, but are not limited to, the count of each of the different types of logic cells, the count of connections in the circuit, and the count of the number of layers in the circuit. The measure of cost may be intended to measure the cost to simulate the circuit in software or the cost to implement the circuit in hardware. For example, the time required to simulate a circuit goes up with the number of logic cells in the circuit, and the number of transistors required to implement a circuit in hardware also goes up with the number of logic cells. Because of that, one numeric measure of the cost of a circuit may be the number of logic cells in the circuit. In some implementations, different logic cells may require different amounts of time to simulate, and have different requirements when being implemented in hardware. As such, to calculate a numeric measure for the cost of a circuit, the counts of each type of logic cell would be individual measures of cost. In various implementations, the selecting of the changed version is based on a numeric value that varies with numeric measures of the cost of the changed version.

Multiple measures for the “better” option may be combined to cause the circuit being generated to be optimized for multiple criteria at once. For example, multiplying the number of connections times the number of errors would result in a measure that could cause a circuit to be optimized for reduced cost and reduced errors at the same time.

The supervisor program 102 is the computer process that evaluates the accumulated statistics and decides to select a changed version in block 204. The evaluation of the accumulated statistics may be a sophisticated process that significantly expedites the method of implementations described herein. Generating accumulated statistics in block 202 takes time and incurs computing costs. In some implementations, the decision in block 204 to continue to generate accumulated statistics is a decision that weighs the potential benefit of discovering a better changed version with the compute cost of continuing to look for it. This evaluation may be done poorly by a simple algorithm, or it may be done more efficiently by a more complex computation that is adaptive and embodies the experience of having trained many different circuits. In an example application, the system may utilize one or more circuits generated by the circuit generation methods described herein, within the supervisor program to make the decision of block 204. Just as computers are used in the process of designing other computers, circuits that are generated by embodiments described herein may be used in the process that generates other circuits. In various implementations, one or more of the generation criteria is generated by applying accumulated statistics to a decision circuit, where the decision circuit is generated by the method of FIG. 2.

At block 206, the system 100 updates the current circuit 104 based on the selected changed version. There are various possible ways to achieve this, and they depend on how the description of the selected changed version is stored. If a description of the selected changed version consists of a change that was applied to the current circuit, the updating of the current circuit may include changing the current circuit to be equal to the selected changed version. If the description of the selected changed version is a complete copy of the current circuit with a change applied to it, the updating of the current circuit may include replacing the current circuit with the selected changed version.

At block 208, the system repeats the method multiple times based on the accumulated statistics 108 until finished. In some implementations, the decision to continue generating statistics is made based on the accumulated statistics 108. The compute cost to improve the circuit may be calculated by multiplying the cost per hour of the compute resources used times the number of hours used to generate the improved circuit. The cost to generate each changed version may be computed in this way. The improvement that a changed version makes may be measured in the error rate reduction that the changed version achieves. In various implementations, the compute cost is a measure of effort, and the improvement each changed version makes is a measure of benefit. In some implementations, the decision to finish may be made when the benefit of a changed version is no longer worth the effort. This decision may be made by dividing the measure of benefit by the measure of effort, and finishing when that number falls below a predetermined threshold.

In various implementations, the generated accumulated statistics step in block 202 has a variety of changes that the system knows how to apply to a circuit. In some implementations, the decision to finish in block 208 may be made when all known changes have been tried, or when all changes of a certain type have been tried. In some implementations, the decision to finish at block 208 may be made when the current circuit 104 has arrived at a state of making no errors on the training set 106.

FIG. 3 illustrates a high-level flow diagram for generating accumulated statistics, according to some implementations. In various implementations, FIG. 3 may be used to implement block 202 of FIG. 2, which generates accumulated statistics.

At block 302, the system generates one or more changed versions of a current circuit. In some implementations, the current circuit includes logic cells that perform Boolean operations. For example, in some implementations, the generating of one or more of the changed versions of the current circuit includes establishing a new logic cell interconnection. In another example, in some implementations, the generating of one or more of the changed versions of the current circuit includes removing a logic cell interconnection. In yet another example, in some implementations, the generating of one or more of the changed versions of the current circuit includes adding a new logic cell. In yet another example, in some implementations, the generating of one or more of the changed versions of the current circuit includes changing the value of a variable used by a logic cell.

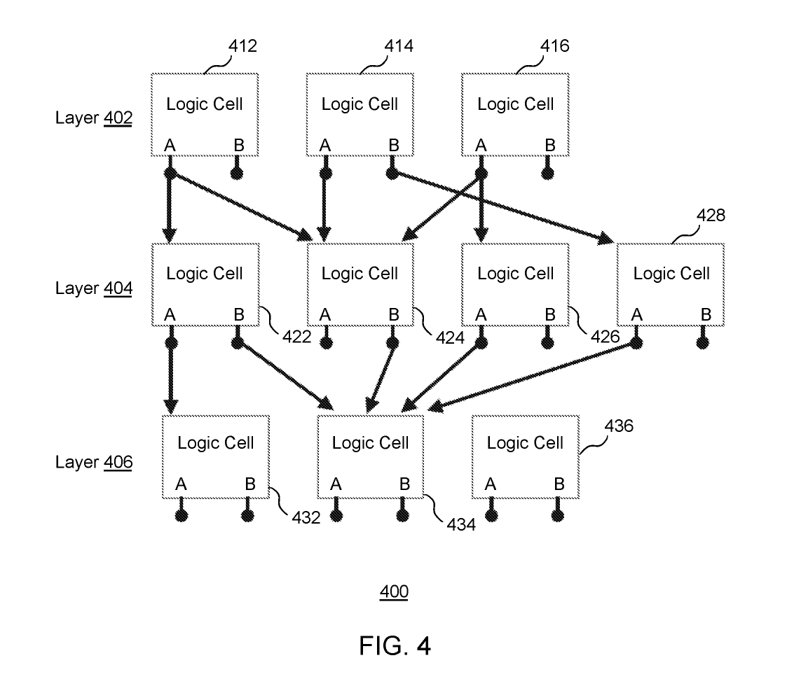

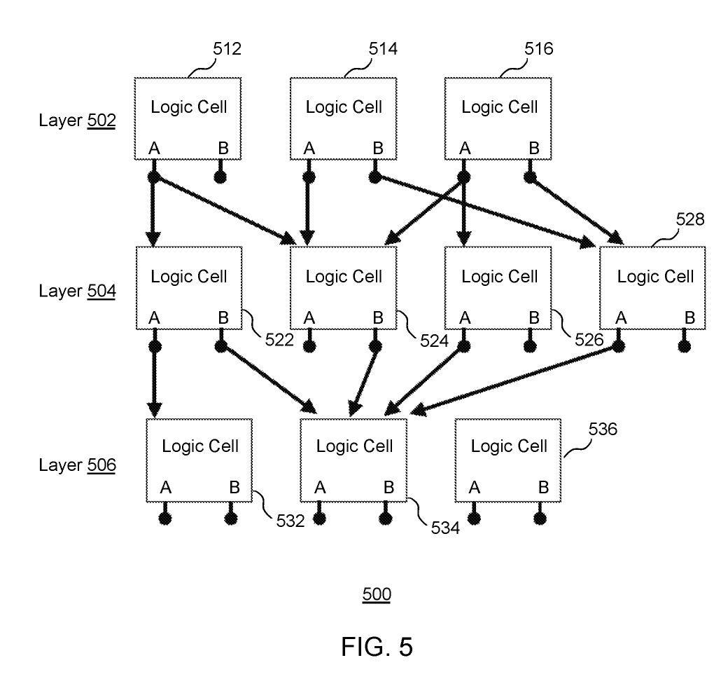

As described in more detail herein, FIG. 4 shows an example current circuit, according to some implementations. FIG. 5 shows an example of a generated changed version of the circuit shown in FIG. 4. Referring briefly to both FIGS. 4 and 5, the change is the establishing of a new logic cell interconnection. Specifically, that change is a new connection from the B output of logic cell 516 to the input of logic cell 528.

In some implementations, generated changed versions of a current circuit may include multiple changes of the types described above. For example a changed version may be one that is generated by adding one cell, adding a input to that cell, adding a output from that cell, and changing an internal variable of the cell connected to the output of the cell that was just added.

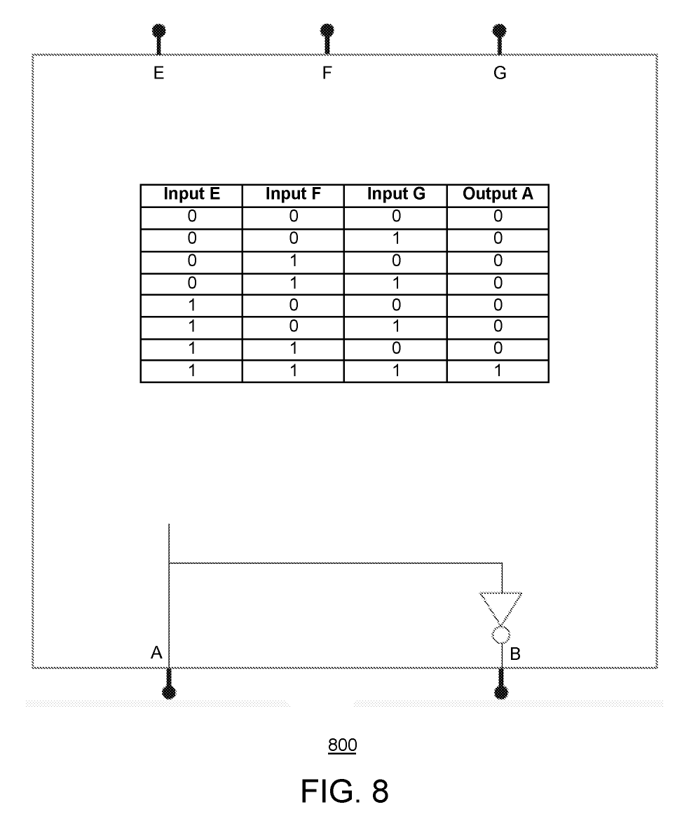

An example of an internal variable to a logic cell is shown in FIG. 8. In FIG. 8, changing the programmed output for a row in the truth table would be changing an internal variable.

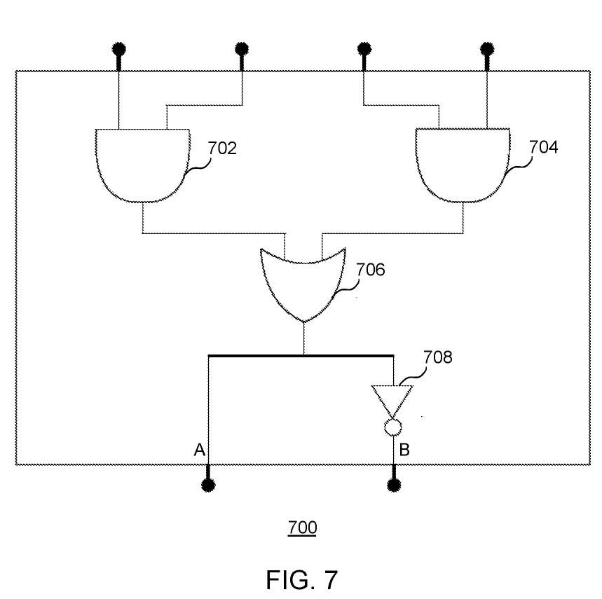

Another example of an internal variable is shown in FIG. 7. In this example, an internal variable determines how many AND operators are in the logic cell. Other internal variables are used to specify which input of the logic cell is connected to which AND operator inside the logic cell.

Referring again to FIG. 3, at block 304, in order to generate the accumulated statistics, the system generates statistics associated with the performance of each changed version based on the application of a training set. In various implementations, the generation of statistics is achieved by the system collecting counts at the outputs of the network. In various implementations, each output of the network is designated to indicate a category of the example applied to the inputs of the network. In the example of a circuit that performs handwriting recognition of the digits “0” through “9”, there will be ten outputs, each designated to indicate that the applied example is a specific digit. In this example, there will be an output that indicates the presence of an image of the digit “3” on the inputs. Sometimes this output will be correct, and it will be True when an image of a “3” is being presented to the network. This output will be incorrect if it is True while an image of a digit other than a “3” is presented to the inputs of the network. A False Positive error occurs when the output is incorrect while it is generating a True output. A False Negative error occurs when the output is incorrect when it is generating a False output.

In some implementations, the statistics generated from the application of a training set to a circuit includes the counts of the number of times each circuit output correctly indicates the category it is designated to indicate. In some implementations, calculating an error rate may be performed by counting the total number of examples presented to the network, counting the False Positives indicated by each output, and counting the False Negatives indicated by each output. In some implementations, the equation for this calculated error rate is the percentage of true positive examples, the correctly inferred examples belonging to the output's category, minus the percentage of false positive examples, where the incorrectly inferred examples do not belong to the output's category.

There are two extremes for how a generated circuit may function to correctly categorize examples in a training set. In the example of a circuit that performs handwriting recognition, the circuit may correctly categorize an image of a “3” by having extracted the essence of what it is to be a “3”. The circuit may identify the image as including two continuous semicircular strokes one on top of the other, with openings that face to the left. This method of categorizing an example is based on performing computations that have been generalized from the examples in the training set in order to identify intermediate features. This method may then use those features to correctly classify the examples in the training set.

The other extreme for how a circuit may correctly categorize examples in a training set is to simply memorize each example exactly, and then indicate when one of the memorized examples is present. This extreme is simply memorizing, and is undesirable. It is the opposite of categorizing examples by means of generalizations and features. The functioning of a generated network by means of memorizing examples in a training set instead of properly generalizing is an observed phenomena that is called “overfitting” in the field of artificial neural networks.

In various implementations, the system prevents the problem of overfitting when circuits are generated from training sets. For example, in some implementations, one way to prevent overfitting is to recognize that overfitting takes place when the generated circuit performs its computation by means of identifying individual or small groups of examples in the training set. In some implementations, a way to prevent the circuit from identifying individual or small groups of examples is to not make any changes to the circuit that only affect individual or small groups of examples. In some implementations, overfitting may be prevented by requiring that each change applied to the circuit results in the circuit functioning differently for at least a minimum number of examples.

In this way, in some implementations, changes are made if they operate on groups of examples, and not individual examples. In some implementations, the system selects the changed version based on a selection criterion that requires that the circuit generates outputs that are different when compared to a previous version for at least a minimum number of examples.

In some implementations, the selection criterion may be that one or more generated signals assume Boolean values that are different compared to a previous version for at least a predetermined number of training set examples in a specific category. This prevents overfitting by requiring that when changes result in selecting additional examples that belong to the category of an output of the network, that those additional examples are a group of a minimum predetermined size. Overfitting can also occur when individual examples are excluded from a specific category.

In some implementations, the selecting of the changed version may be based on a selection criterion that one or more generated signals assume Boolean values that are different compared to a previous version for at least a predetermined number of training set examples that are not in a specific category. This prevents overfitting by requiring that changes, which result in excluding additional examples that do not belong to the category of an output of the network, that those additional examples are a group of a minimum size.

Referring again to FIG. 3, at block 306, the system adds the generated statistics associated with each changed version to the accumulated statistics. Block 204 in FIG. 2 is the step of selecting a changed version. In some implementations, the information used to determine the selection of a changed version is contained in the description of the changed version and contained in the accumulated statistics stored with the description of the changed version. One version of a computer program that performs this method stores the statistics generated by applying the training set to the changed version. These statistics may include the generated outputs of the circuit for each example in the training set. The generated outputs of the net for a changed version of the circuit may be compared to the previous generated outputs; and a count is made of the number of times the outputs of changed version differs from the previous version. This count may be used to determine selection criteria that prevent overfitting.

Although the steps, operations, or computations may be presented in a specific order, the order may be changed in particular implementations. Other orderings of the steps are possible, depending on the particular implementation. In some particular implementations, multiple steps shown as sequential in this specification may be performed at the same time. Also, some implementations may not have all of the steps shown and/or may have other steps instead of, or in addition to, those shown herein.

FIG. 4 illustrates a block diagram of an example of the current circuit 400, according to some implementations. Shown are logic cell layers 402, 404, and 406. Layer 402 may be referred to as a first layer, layer 404 may be referred to as a second layer, layer 406 may be referred to as a third layer. As shown, layer 402 includes logic cells 412, 414, and 416. Layer 404 includes logic cells 422, 424, 426, and 428. Layer 406 includes logic cells 432, 434 and 436. This example shows one type of current circuit that is organized in layers, and the connections between logic cells are restricted to be between the output of a logic cell in one layer and the input of a logic cell in the next layer. The inputs to circuit 400 are inputs to cells 412, 414, and 416 in first layer 402; and the outputs of circuit 400 are the outputs of cells 432, 434, and 436 in last layer 406. As shown, output A of cell 412 provides input to cells 422 and 424. Note the terms logic cell and cell may be used interchangeably.

FIG. 5 illustrates a block diagram of an example of a changed circuit 500, according to some implementations. Shown are logic cell layers 502, 504, and 506. Layer 502 may be referred to as a first layer, layer 504 may be referred to as a second layer, layer 506 may be referred to as a third layer. As shown, layer 502 includes logic cells 512, 514, and 516. Layer 504 includes logic cells 522, 524, 526, 528. Layer 506 includes logic cells 532, 534 and 536. FIG. 5 shows a circuit 500 that is changed from the circuit shown in FIG. 4, by the addition of a single connection between logic cell 516 and logic cell 528. Circuit 500 may become the current circuit if selected.

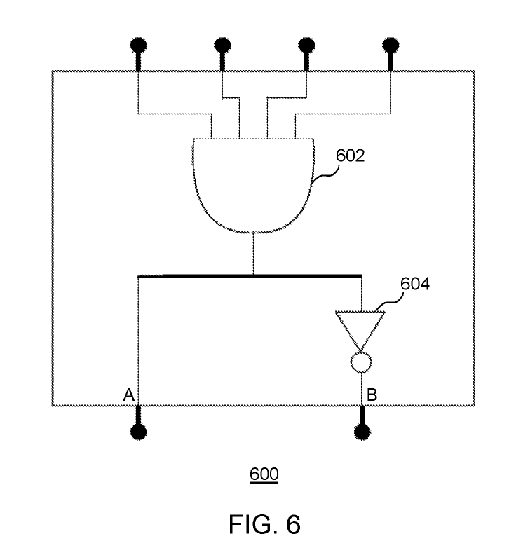

FIG. 6 illustrates a block diagram for one particular example type of logic cell 600, according to some implementations. As shown, an AND gate 602 has an inverter 604 at one of its outputs. Logic cell 600 is an example of logic cell 434 of FIG. 4, or an example of other logic cells of FIG. 4. Logic cell 600 performs the Boolean AND operation of four Boolean inputs. This logic cell generates two Boolean outputs A and B, where the first output A is the logical AND of the inputs of the logic cell, and the second output B is the logical inversion of the first output of gate 602. In some implementations, the generating of the statistics may include setting at least one logic cell output equal to a logical AND of internal signals, where one or more of the internal signals are equal to logic cell inputs.

Another type of logic cell would be the logic cell shown in FIG. 6 with the logical OR operation replacing the logical AND operation. In some implementations, the generating of the statistics includes setting at least one logic cell output equal to a logical OR of internal signals, and where one or more of the internal signals are equal to logic cell inputs.

FIG. 7 illustrates a block diagram for an example logic cell 700 with a more complex Boolean operation, according to some implementations. Shown are AND gates 702 and 704, OR gate 706, where OR gate 706 has an inverter 708 at an output. In some implementations, the generating of the statistics includes setting at least one logic cell output equal to a logical OR of outputs of multiple logical AND operations of internal signals, where one or more of the internal signals are equal to logic cell inputs. Logic cell 700 is a possible example of logic cell 534 of FIG. 5, or an example of other logic cells of FIG. 5. This logic cell is Boolean, having inputs that are Boolean signals, performing Boolean operations, and having outputs that are Boolean. This logic cell performs the logical sum of products, which is the logical OR of the output's logical AND operations, with each AND operation having one or more inputs.

Logic cell 700 is an example of a logic cell having internal variables, one variable indicating the number of internal logical AND operations, and other variables indicating which logic cell input is connected to each of the internal logical AND operations. As shown in FIG. 7, logic cell 700 has two outputs, the first output being the output of the logic inside the logic cell, and the second output being the logical inversion via inverter 708 of the first output.

FIG. 8 illustrates a block diagram for an example Boolean logic cell 800 that generates its outputs based on a truth table, according to some implementations. Logic cell 800 is an example of logic cell 524 of FIG. 5, or an example of other logic cells of FIG. 5. The table shown in FIG. 8 is an example of a truth table with input E, input F, and input G, and there is one horizontal row for every possible combination of the inputs. The output row shown in the table is the programming example of the truth table that would perform the logical AND of the three inputs. In general, every row of the table may be programmed independently, and the states programmed in the output A column are internal states to this logic cell 800. In this example, the generating of the statistics includes setting at least one logic cell output, where the setting of the at least one logic cell output includes generating a key based on values of logic cell inputs having Boolean values, accessing the table with the key to obtain an associated value; and setting a logical cell output to equal the associated value.

Logic cells of a wide variety of functionality may be trained with the method of implementations described herein. Another type of useful logic cell is one that has numeric inputs and Boolean outputs. This is useful functionality because many kinds of data that may be applied to machine learning are numeric, and Boolean logic for computation is preferable. One possible numeric to Boolean function could be “approximately equal,” where Boolean output signals that multiple numeric inputs are equal to within a predetermined measure. Another interesting numeric to Boolean function may include “approximately zero,” where an input is below a threshold. Another numeric may include “large,” where an input exceeds a threshold. Another numeric may include “ascending,” where a group of inputs are ordered and are increasing. Another numeric may include “descending,” where a group of inputs are ordered and are decreasing. The numeric values that are used for thresholds, or “approximately equal” operations may be the values of other inputs, or the values of variables that are set outside of the cell. In various implementations, the generating of the statistics includes setting at least one logic cell output to a Boolean value based on multiple logic cell inputs having numeric values.

In various implementations, logic cells of different types may be arranged in different layers of a circuit. For example, the circuit shown in FIG. 4 may have layer 402 that may include logic cells that have numeric inputs and Boolean outputs. Layer 404 may include logic cells that perform the logical AND operation (e.g., described in FIG. 6, etc.). Layer 406 may include logic cells that perform the logical OR operation. Constraining the types of logic cells in specific layers of a net being generated is one way to simplify the operation of the net. This simplification of the net reduces the types of changes that can be applied to logic cells in a specific layer, and the reduction in the types of changes that can be made in turn speeds the process described in FIG. 3. And by speeding the process described in FIG. 3, the process of generating a circuit is made more efficient. One way to beneficially constrain the network being generated is restrict the net to include alternating layers of AND logic cells and OR logic cells. As such, in some implementations, the generating of the statistics may include using a circuit that includes alternating layers of AND logic cells with layers of OR logic cells. In more generalized implementations, where complex cells other than AND logic cells are being used, it can still be a beneficial constraint to require that layers of these complex cells are alternated with layers of the more simple OR logic cells. The generating of the statistics may include using a circuit that has layers of logic cells, where multiple layers include logic cells that perform a logical OR operation, and where the layers of the logical OR operation are separated by layers that include logic cells that perform logical operations that are not a logical OR operation.

In various implementations, a normal training set includes training examples, where each example is a collection of data. Part of that collection of data is applied to the circuit inputs when the example is applied to a circuit. Part of that collection of data is additional information that may include a category to which the example belongs. In the application example of the training set of handwritten digits, each training example includes an image and a category. The image is an array of values corresponding to the pixels in the image. When one of these examples is applied to the circuit, each pixel corresponds to one of the circuit inputs, and its value is set to that circuit input. When stored on a computer, the data for an example is frequently stored as a vector, which is an ordered sequence of data. A typical training vector in a training set contains the values of all the circuit inputs for one training example.

In some implementations, the data representation used in generating statistics associated with performance of each changed version may be a different type of vector, called a signal vector. This alternate vector representation is valuable, because it speeds the computation of the statistics associated with a changed version in a network of Boolean logic cells. Whereas a normal example vector is a collection of the values of a number of different signals (circuit input signals) associated with one example, the signal vector is a collection of the values that a single signal has for every different example in the training set. In the application example of the training set of handwriting samples, where each sample is bitmap of a handwritten digit, the first bit in the top left corner is almost always white. This is because the digits tend to be drawn in the center of a bitmap. In the example vector representation, this means that the first bit in every example vector is almost always zero (for white). In contrast, the signal vector representation for the signal representing the first bit in the top left corner is a vector that includes almost all zeros.

The signal vector representation is a very fast structure for Boolean signals, because the value of a signal may be represented in a single bit. A normal data word in a modern computer processor is 64 bits long. As such, the signal vector representation of a signal for 64 Boolean examples may be efficiently packed into one data word. In some implementations, the application of the training set to at least one logic cell is performed in parallel, where the logic cell inputs of the one logic cell have values that are Boolean vectors. In some implementations, each bit of a Boolean vector represents a value of the logic cell input for one training set example. Internal logic of the at least one logic cell performs vector operations to generate a vector value for at least one logic cell output.

When the operations in a Boolean logic cell are either logical AND or logical OR, modern computer processors can perform these operations on a signal vector by using bitwise AND and OR instructions which are therefore able to process 64 examples in a single instruction step. This offers a significant speed advantage for the generation of Boolean logic circuits. For an even greater speed advantage, custom electronic hardware could be used to perform bitwise logical operations of two signal vectors. In some implementations, the system may perform a bitwise AND operation of two input vectors having variable lengths greater than a word. In some implementations, the system may perform a bitwise OR operation of two input vectors having variable lengths greater than a word.

Other generated statistics calculations are also speeded up by the signal vector representation. Counting the number of examples for which a given signal has a value of “1”, or True, in the training set, amounts to counting the “1”s in the signal vector for the given signal. Conversely, counting the number of times an output signal is False for the examples in a training set amounts to counting the “0”s in the signal vector for the given signal.

Many modern computer processors offer a population count (POPCNT) instruction, which counts the number of “1” bits in a data word. This instruction makes counting the “1”s in a signal vector very fast and efficient. In some implementations this computation can be sped up with custom circuitry that when executed is further operable to perform operations including counting a number of bits set to “1” or “0” in a Boolean input vector having a variable length greater than a word. In some implementations, the system counts a number of bits set to “1” in a Boolean input vector having a variable length greater than a word. In some implementations, the system counts a number of bits set to “0” in a Boolean input vector having a variable length greater than a word. The counting of the number of bits set to “1” or “0” is frequently performed after the logical AND and OR operation of two vectors having variable lengths, and custom hardware can be created to speed the calculation of both operations simultaneously. In this situation, the custom hardware can be constructed to perform a logical bitwise AND or OR operation of two input vectors having variable lengths greater than a word, and to count the number of bits set to “1” or “0” set in the resulting Boolean output vector at the same time.

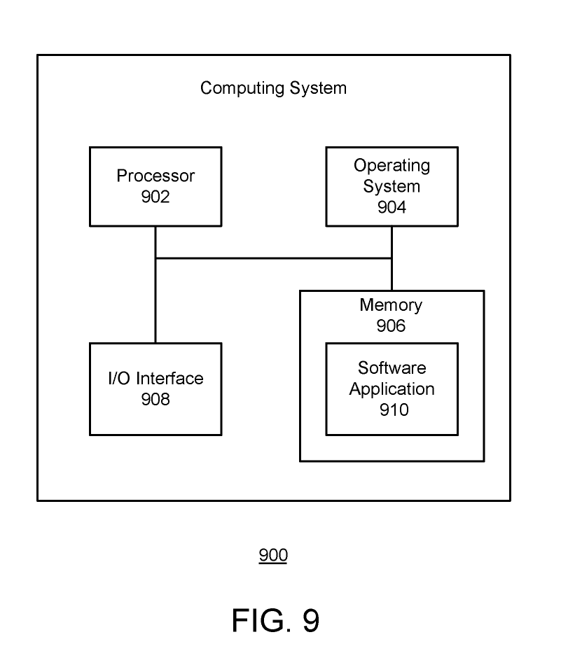

FIG. 9 illustrates a block diagram of an example computing system 900, which may be used for some implementations described herein. For example, computing system 900 may be used for implementations described herein. In some implementations, computing system 900 may include a processor 902, an operating system 904, a memory 906, and an input/output (I/O) interface 908. In various implementations, processor 902 may be used to implement various functions and features described herein, as well as to perform the method implementations described herein. While processor 902 is described as performing implementations described herein, any suitable component or combination of components of computing system 900 or any suitable processor or processors associated with computing system 900 or any suitable system may perform the steps described. Implementations described herein may be carried out on a user device, on a server, or a combination of both.

Computing system 900 also includes a software application 910, which may be stored on memory 906 or on any other suitable storage location or computer-readable medium. Software application 910 provides instructions that enable processor 902 to perform the implementations described herein and other functions. Software application 910 may also include an engine such as a network engine for performing various functions associated with one or more networks and network communications. The components of computing system 900 may be implemented by one or more processors or any combination of hardware devices, as well as any combination of hardware, software, firmware, etc.

For ease of illustration, FIG. 9 shows one block for each of processor 902, operating system 904, memory 906, I/O interface 908, and software application 910. These blocks 902, 904, 906, 908, and 910 may represent multiple processors, operating systems, memories, I/O interfaces, and software applications. In various implementations, computing system 900 may not have all of the components shown and/or may have other elements including other types of components instead of, or in addition to, those shown herein.

In various implementations, computing system 900 includes logic encoded in one or more non-transitory computer-readable storage media for execution by the one or more processors. When executed, the logic is operable to perform operations associated with implementations described herein.

Although the description has been described with respect to particular embodiments thereof, these particular embodiments are merely illustrative, and not restrictive. Concepts illustrated in the examples may be applied to other examples and implementations.

In various implementations, software is encoded in one or more non-transitory computer-readable media for execution by one or more processors. The software when executed by one or more processors is operable to perform the implementations described herein and other functions.

Any suitable programming language can be used to implement the routines of particular embodiments including C, C++, Java, assembly language, etc. Different programming techniques can be employed such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time.

Particular embodiments may be implemented in a non-transitory computer-readable storage medium (also referred to as a machine-readable storage medium) for use by or in connection with the instruction execution system, apparatus, or device. Particular embodiments can be implemented in the form of control logic in software or hardware or a combination of both. The control logic when executed by one or more processors is operable to perform the implementations described herein and other functions. For example, a tangible medium such as a hardware storage device can be used to store the control logic, which can include executable instructions.

Particular embodiments may be implemented by using a programmable general purpose digital computer, and/or by using application specific integrated circuits, programmable logic devices, field programmable gate arrays, optical, chemical, biological, quantum or nanoengineered systems, components and mechanisms. In general, the functions of particular embodiments can be achieved by any means as is known in the art. Distributed, networked systems, components, and/or circuits can be used. Communication, or transfer, of data may be wired, wireless, or by any other means.

A “processor” may include any suitable hardware and/or software system, mechanism, or component that processes data, signals or other information. A processor may include a system with a general-purpose central processing unit, multiple processing units, dedicated circuitry for achieving functionality, or other systems. Processing need not be limited to a geographic location, or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory. The memory may be any suitable data storage, memory and/or non-transitory computer-readable storage medium, including electronic storage devices such as random-access memory (RAM), read-only memory (ROM), magnetic storage device (hard disk drive or the like), flash, optical storage device (CD, DVD or the like), magnetic or optical disk, or other tangible media suitable for storing instructions (e.g., program or software instructions) for execution by the processor. For example, a tangible medium such as a hardware storage device can be used to store the control logic, which can include executable instructions. The instructions can also be contained in, and provided as, an electronic signal, for example in the form of software as a service (SaaS) delivered from a server (e.g., a distributed system and/or a cloud computing system).

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

What is claimed is:

1. A computer-implemented method for generating a circuit, the method comprising:
generating accumulated statistics, wherein the generating of the accumulated statistics is repeated based on one or more generation criteria, and wherein the generating of the accumulated statistics comprises:
generating one or more changed versions of a current circuit, wherein the current circuit comprises a plurality of logic cells that perform Boolean operations;
generating statistics associated with performance of the one or more changed versions based on the application of a training set to each changed version; and
adding the generated statistics associated with each changed version to the accumulated statistics;
wherein the method further comprises:
selecting a changed version from the one or more changed versions based on the accumulated statistics;
updating the current circuit based on the selected changed version; and
repeating the method a plurality of times based on the accumulated statistics.

2. The method of claim 1, wherein the generating of one or more of the changed versions of the current circuit comprises establishing a new logic cell interconnection.

3. The method of claim 1, wherein the generating of one or more of the changed versions of the current circuit comprises removing a logic cell interconnection.

4. The method of claim 1, wherein the generating of one or more of the changed versions of the current circuit comprises adding a new logic cell.

5. The method of claim 1, wherein the generating of one or more of the changed versions of the current circuit comprises changing a value of a variable used by a logic cell.

6. The method of claim 1, wherein the generating of the statistics comprises setting at least one logic cell output equal to a logical AND of internal signals, and wherein one or more of the internal signals are equal to logic cell inputs.

7. The method of claim 1, wherein the generating of the statistics comprises setting at least one logic cell output equal to a logical OR of internal signals, and wherein one or more of the internal signals are equal to logic cell inputs.

8. The method of claim 1, wherein the generating of the statistics comprises setting at least one logic cell output equal to a logical OR of outputs of a plurality of logical AND operations of internal signals, and wherein one or more of the internal signals are equal to logic cell inputs.

9. The method of claim 1, wherein the generating of the statistics comprises setting at least one logic cell output, and wherein the setting of the at least one logic cell output comprises:
generating a key based on values of a plurality of logic cell inputs having Boolean values;
accessing a table with the key to obtain an associated value; and
setting a logical cell output to equal the associated value.

10. The method of claim 1, wherein the generating of the statistics comprises setting at least one logic cell output to a Boolean value based on a plurality of logic cell inputs having numeric values.

11. The method of claim 1, wherein the generating of the statistics comprises using a circuit comprising layers of logic cells, wherein a plurality of layers comprise logic cells that perform a logical OR operation, and wherein layers of the logical OR operation cells are separated by layers comprising logic cells that perform logical operations that are not a logical OR operation.

12. The method of claim 1, wherein the generating of the statistics comprises:
counting false positive inferences; and
counting false negative inferences.

13. The method of claim 1, wherein the selecting of the changed version is based on a numeric value that varies with numeric measures of a cost of the changed version.

14. The method of claim 1, wherein the selecting of the changed version is based on a selection criterion that one or more generated signals assume Boolean values that are different compared to a previous version for at least a predetermined number of training set examples in a specific category.

15. The method of claim 1, wherein the selecting of the changed version is based on a selection criterion that one or more generated signals assume Boolean values that are different compared to a previous version for at least a predetermined number of training set examples that are not in a specific category.

16. The method of claim 1, wherein the updating of the current circuit comprises changing the current circuit to be equal to the selected changed version.

17. The method of claim 1, wherein the updating of the current circuit comprises replacing the current circuit with the selected changed version.

18. The method of claim 1, wherein the application of the training set to at least one logic cell is performed in parallel, wherein a plurality of logic cell inputs of the at least one logic cell has values that are Boolean vectors, wherein each bit of a Boolean vector represents a value of the logic cell input for one training set example, and wherein internal logic of the at least one logic cell performs vector operations to generate a vector value for at least one logic cell output.

19. The method of claim 1, wherein one or more of the generation criteria is generated by applying accumulated statistics to a decision circuit, wherein the decision circuit is generated by the method of claim 1.

20. A non-transitory computer-readable storage medium carrying program instructions thereon, the instructions when executed by one or more processors are operable to perform operations comprising:
generating accumulated statistics, wherein the generating of the accumulated statistics is repeated based on one or more generation criteria, and wherein the generating of the accumulated statistics comprises:
generating one or more changed versions of a current circuit, wherein the current circuit comprises a plurality of logic cells that perform Boolean operations; and
generating statistics associated with performance of the one or more changed version based on application of a training set to each changed version;
adding the generated statistics associated with each changed version to the accumulated statistics;
wherein the instructions when executed are further operable to perform operations comprising:
selecting a changed version from the one or more changed versions based on the accumulated statistics;
updating the current circuit based on the selected changed version; and
repeating the method a plurality of times based on the accumulated statistics.

21. A system comprising:
one or more processors;
logic encoded in one or more non-transitory computer-readable storage media for execution by the one or more processors and when executed operable to perform operations comprising:
generating accumulated statistics, wherein the generating of the accumulated statistics is repeated based on one or more generation criteria, and wherein to generate the accumulated statistics, the logic when executed is further operable to perform operations comprising:
generating one or more changed versions of a current circuit, wherein the current circuit comprises a plurality of logic cells that perform Boolean operations; and
generating statistics associated with performance of the one or more changed versions based on the application of a training set to each changed version;
adding the generated statistics associated with each changed version to the accumulated statistics;
wherein the logic when executed is further operable to perform operations comprising:
selecting a changed version from the one or more changed versions based on the accumulated statistics;
updating the current circuit based on the selected changed version; and
repeating the method a plurality of times based on the accumulated statistics.

22. The system of claim 20, wherein the logic when executed is further operable to perform operations comprising performing a bitwise AND operation of two input vectors having variable lengths greater than a word.

23. The system of claim 20, wherein the logic when executed is further operable to perform operations comprising performing a bitwise OR operation of two input vectors having variable lengths greater than a word.

24. The system of claim 20, wherein the logic when executed is further operable to perform operations comprising counting a number of bits set to “1” in a Boolean input vector having a variable length greater than a word.

25. The system of claim 20, wherein the logic when executed is further operable to perform operations comprising counting a number of bits set to “0” in a Boolean input vector having a variable length greater than a word.

26. The system of claim 20, wherein the logic when executed is further operable to perform operations comprising performing a bitwise OR operation of two input vectors having variable lengths greater than a word and counting the number of bits set to “1” in the resulting Boolean output vector.

27. The system of claim 20, wherein the logic when executed is further operable to perform operations comprising performing a bitwise OR operation of two input vectors having variable lengths greater than a word and counting the number of bits set to “0” in the resulting Boolean output vector.

28. The system of claim 20, wherein the logic when executed is further operable to perform operations comprising performing a bitwise AND operation of two input vectors having variable lengths greater than a word and counting the number of bits set to “1” in the resulting Boolean output vector.

29. The system of claim 20, wherein the logic when executed is further operable to perform operations comprising performing a bitwise AND operation of two input vectors having variable lengths greater than a word and counting the number of bits set to “0” in the resulting Boolean output vector.

30. The system of claim 20, wherein the generating of the statistics comprises using a circuit that includes alternating layers of AND logic cells with layers of OR logic cells.
